(19) United States
(12) Patent Application Publication
(10) Pub. No.: US 2010/0153732 A1
(43) Pub. Date: Jun. 17, 2010

(54) CACHE-BASED METHOD OF HASH-TREE MANAGEMENT FOR PROTECTING DATA INTEGRITY

(75) Inventor: Lifeng Su, Aix en Provence (FR)

Correspondence Address: SEED INTELLECTUAL PROPERTY LAW GROUP PLLC, 701 FIFTH AVENUE, SUITE 5400, SEATTLE, WA, 98104-7092, US

(73) Assignee: STMICROELECTRONICS ROUSSET SAS, Rousset (FR)

(21) Appl. No.: 12/578,319

(22) Filed: Oct. 13, 2009

(30) Foreign Application Priority Data
Dec. 15, 2008 (FR) 0807040

(51) Int. Cl. H04L 9/00

(52) U.S. Cl. 713/176

(57) ABSTRACT

The present disclosure relates to accessing data stored in a secure manner in an unsecure memory, based on signatures forming an integrity check tree comprising a root signature stored in a secure storage space, and lower-level signatures stored in the unsecure memory. One embodiment calculates a first-level signature from the data in a group comprising a changed datum, and temporarily stores the signature calculated in a secure memory. The embodiment calculates a signature to check the integrity of a lower-level signature by using the signature to be checked and a second signature belonging to a same group as the signature to be checked, read as a priority in the secure memory and in the unsecure memory if it has different values in the secure and unsecure memories.

### BACKGROUND

1. Technical Field

The technical field relates to storing data in a secure manner in an unsecure storage space.

2. Description of the Related Art

Below, the word “secure” when applied to a datum means a datum benefitting from measures designed to guarantee its integrity. When applied to a data processing or storage unit, this word means a unit benefiting from measures designed to guarantee the integrity of the data handled or stored in it.

Systems exist, such as microcircuit boards, which comprise a secure data storage space. However, this storage space generally has a capacity insufficient for storing all the sensitive data of one or more applications set up in the system. Such a system is therefore commonly associated with an unsecure memory. To secure the data in the unsecure memory, it has been considered to use an integrity check tree such as a Merkle tree which enables a set of data to be secured using a single signature which is stored in a secure storage space.

An integrity check tree comprises first-level signatures calculated on groups of data from the set of data, higher-level signatures calculated on groups of lower-level signatures, and a root signature calculated on a group of the highest-level signatures. Below, the word “signature” means the result of a hashing function applied to a set of data. A hashing function has the properties of producing, with a very low probability, an identical signature from two different sets of data, and of not enabling within a reasonable period of time a set of data which generates a known signature to be found.

The check of a datum using a root signature requires obtaining all the data of the group to which the datum to be checked belongs, calculating the signature of the group of data, comparing the signature obtained with the signature stored, and repeating these operations with all the groups to which the signatures obtained belong until a last signature concerning the group of the highest-level signatures is calculated, and comparing the last signature obtained with the root signature, the integrity of the datum being validated if the last signature obtained corresponds to the root signature. By saving in a secure manner only the root signature, it is thus possible to check the integrity of the data and of all the other signatures, without the need for storing this information in a secure storage space.

Each change of a datum requires a prior check of the integrity of the datum and an update of the integrity check tree. Such an update is done by calculating the signature of the group of data to which the changed datum belongs, and by calculating the signature of each group comprising a changed signature up to the root signature.

These checking and updating operations contribute to significantly slowing down the access to the external memory. This performance impairment is related to the number of levels of the integrity check tree and therefore to the quantity of data to be secured.

Furthermore, these checking and updating operations often prove to be redundant. Indeed, when a datum is updated, all the signatures of the branch on the integrity check tree located between the datum and the root signature must be recalculated and saved in the memory. If the same datum is changed again, the same signatures must be recalculated and saved.

### BRIEF SUMMARY

Various embodiments simplify the secure data integrity check operations using an integrity check tree and the operations of updating such data.

According to one embodiment, a method is provided for accessing data stored in a secured manner in an unsecure memory, based on signatures forming an integrity check tree comprising a root signature stored in a secure storage space and signatures with levels lower than the root signature, stored in the unsecure memory, the integrity of a datum being checked by calculating the signatures in the integrity check tree, from the signature of a group of data to which the datum to be checked belongs, up to the root signature, and by comparing the calculated signatures with corresponding signatures stored in the storage space. According to one embodiment, the method comprises a step of calculating a first-level signature from data in a group comprising a changed datum, and of temporarily storing the calculated signature in a secure memory, the calculation of a signature to check the integrity of a lower-level signature being done using the signature to be checked and a second signature belonging to a same group as the signature to be checked, the second signature being read as a priority in the secure memory and in the unsecure memory if it has different values in the secure and unsecure memories.

According to one embodiment, a datum is considered consistent and accurate when a signature calculated upon an integrity check of the datum corresponds to a signature read in the secure memory.

According to one embodiment, only a first-level signature is calculated and stored in the secure memory following the modification of a datum, a higher-level signature being updated when the number of signatures having different values in the secure memory and in the unsecure memory exceeds a certain threshold.

According to one embodiment, a signature is stored in the secure memory in association with an indicator signaling that the signature has different values in the secure memory and in the unsecure memory.

According to one embodiment, the secure memory has a capacity lower than the capacity necessary to store all the signatures with levels lower than the root signature in the integrity check tree.

According to one embodiment, the method comprises steps of writing a changed signature value in the secure memory in a location not occupied by a signature having different values in the secure memory and in the unsecure memory, and of saving in the unsecure memory a signature having different values in the secure memory and in the unsecure memory if a threshold number of signatures having different values in the secure memory and in the unsecure memory is reached.

In one embodiment, a system of processing data is also provided comprising a secure memory and an unsecure memory, the system being configured for storing data in a secure manner in the unsecure memory, based on signatures forming an integrity check tree comprising a root signature stored in a secure storage space and signatures with levels lower than the root signature, stored in the unsecure memory, and for checking the integrity of a datum by calculating the signatures in the integrity check tree, from the signature of a group of data to which the datum to be checked belongs, up to the root signature, and by comparing the calculated signatures with corresponding signatures stored in the storage space. According to one embodiment, the system is configured for calculating a first-level signature from data in a group comprising a changed datum, and temporarily storing the signature calculated in the secure memory, and for calculating a signature to check the integrity of a lower-level signature, using the signature to be checked and a second signature belonging to a same group as the signature to be checked, read as a priority in the secure memory and in the unsecure memory if it has different values in the secure and unsecure memories.

According to one embodiment, the system is configured for considering a datum to be consistent and accurate when a signature calculated upon an integrity check of the datum corresponds to a signature read in the secure memory.

According to one embodiment, the system is configured for calculating only a first-level signature and storing it in the secure memory following the modification of a datum, and for updating a higher-level signature when the number of signatures having different values in the secure memory and in the unsecure memory exceeds a certain threshold.

According to one embodiment, the system is configured for storing a signature in the secure memory in association with an indicator signaling that the signature has different values in the secure memory and in the unsecure memory.

According to one embodiment, the secure memory has a capacity lower than the capacity necessary to store all the signatures with levels lower than the root signature in the integrity check tree.

According to one embodiment, the system comprises a processing unit, an integrity check tree management unit connected to the processing unit, and a control unit connected to the management unit, to the secure memory and to the unsecure memory, the management unit being configured for executing read and write commands for reading and writing a secure datum sent by the processing unit while checking the integrity of the datum to be read or to be written using the integrity check tree.

According to one embodiment, the control unit is configured for executing commands sent by the management unit for reading and updating a signature in the integrity check tree, for reading a signature in the unsecure memory if the signature has different values in the secure and unsecure memories, and for saving in the unsecure memory a changed signature stored in the secure memory.

According to one embodiment, the control unit is configured for controlling a filling rate of the secure memory in changed signatures not saved in the unsecure memory.

According to one embodiment, the management unit, the control unit and the secure memory are produced in a coprocessor connected between the processing unit and the unsecure memory.

According to one embodiment, the secure memory stores for each signature a signature value, a storage address for storing the signature in the unsecure memory and a counter value TS which is updated every time the signature is written or every time the signature is written and read, the control unit using the counter value to determine a signature stored in the secure memory which was the least recently written or the least recently read or written.

### BRIEF DESCRIPTION OF THE SEVERAL VIEWS OF THE DRAWINGS

Examples of embodiments will be described below in relation with, but not limited to, the following figures, in which:

FIG. 1 schematically represents a secure data processing system according to one embodiment, connected to an external memory,

FIG. 2 represents a data integrity check tree,

FIG. 3 schematically represents the content of a cache memory in which signatures are temporarily stored,

FIGS. 4 to 13 are flowcharts showing processing sequences performed in the system represented in FIG. 1.

### DETAILED DESCRIPTION

FIG. 1 represents a secure data processing system SOC comprising a central processing unit CPU and an interface unit COP connected to an unsecure external memory EMEM. The interface unit COP comprises an integrity check tree management unit HTM, a control unit CCU for controlling a cache memory connected to the unit HTM and to the external memory EMEM and a cache memory CMEM connected to the unit CCU. The interface unit COP is for example produced in the form of a specialized coprocessor.

The memory EMEM stores data to be secured DTV and signatures HTV of an integrity check tree. The unit HTM provides the unit CPU with access services for accessing the data DTV in the memory EMEM. The unit HTM exchanges different control and data signals with the unit CCU. The unit HTM thus supplies the unit CCU with a read or write select signal RW, a control signal CMD, and receives from the unit CCU a signal H indicating whether or not the accessed datum is in the cache memory CMEM, a signal D indicating whether or not the accessed datum, stored in the cache memory, is different from the corresponding datum in the memory EMEM, and a signal F indicating whether or not a filling rate threshold indicating the space in the memory CMEM filled with data not saved in the memory EMEM is reached. Furthermore, the units HTM and CCU are connected to each other by an address and data bus ADB to transmit addresses and data to be memory accessed. The unit CPU can be connected to the unit HTM in the same way as if the unit HTM was a memory.

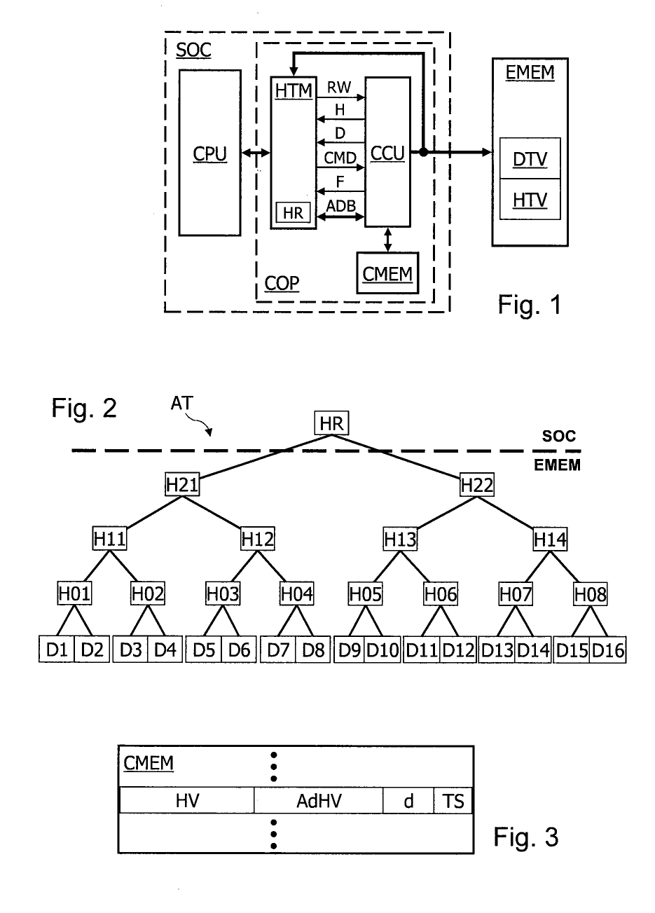

FIG. 2 represents a simplified example of an integrity check tree AT. In this example, 16 data D1 to D16 are secured. The data D1 to D16 are grouped together into 8 groups of data. The tree AT comprises a first-level signature H01 to H08 calculated for each of the 8 groups of data, a second-level signature H11 to H14 calculated for each of 4 groups of first-level signatures H01 to H08, a third-level signature H21, H22 calculated for each of 2 groups of second-level signatures H11 to H14, and a root signature HR calculated on a single group of the third-level signatures H21, H22. The signature HR is stored in a secured manner for example by the unit HTM.

The integrity check tree AT represented in FIG. 2 is a binary tree as each group of data or of signatures comprises two data or two signatures of lower level. It will be understood that the use of an integrity check tree, in which each signature is calculated on a group of data or of signatures comprising more data or signatures, for example 4, may be considered. In this last case, the integrity check tree is a quaternary tree.

Each signature is obtained using a hashing function concerning all the previously concatenated data or signatures of a group. The hashing function chosen may for example be MD5, SHA-1, or the like.

FIG. 3 represents the cache memory CMEM in which each signature value HV stored is associated with the address of the signature AdHV in the memory EMEM and an indicator d signaling whether or not the signature stored in the memory CMEM has been changed compared to the one stored in the memory EMEM. It shall be noted that if the indicator d associated with a signature indicates that the signature has been changed in the memory CMEM without updating the memory EMEM, this also means that the higher-level signatures of the changed signature have not been updated further to the modification of the changed signature.

According to one embodiment, the units HTM and CCU are configured to enable the integrity of a datum D1-D16 to be checked as rapidly as possible. For this purpose, at the end of a successful integrity check of a datum, the integrity of the signatures loaded into the cache memory CMEM has been checked. As the memory CMEM is secure, it is quite unlikely that a signature in the cache memory can be altered. Thus, the integrity of a datum can be considered valid, as soon as a signature belonging to the branch linking the datum to the root signature is read in the cache memory and corresponds to a calculated signature.

According to one embodiment, the units HTM and CCU are also configured to enable a changed signature to be written in the memory EMEM as late as possible. The result is that it is accepted not only that the signatures stored by the memories CMEM and EMEM are not consistent with each other, but also that the integrity check tree AT in the memory EMEM is also inconsistent.

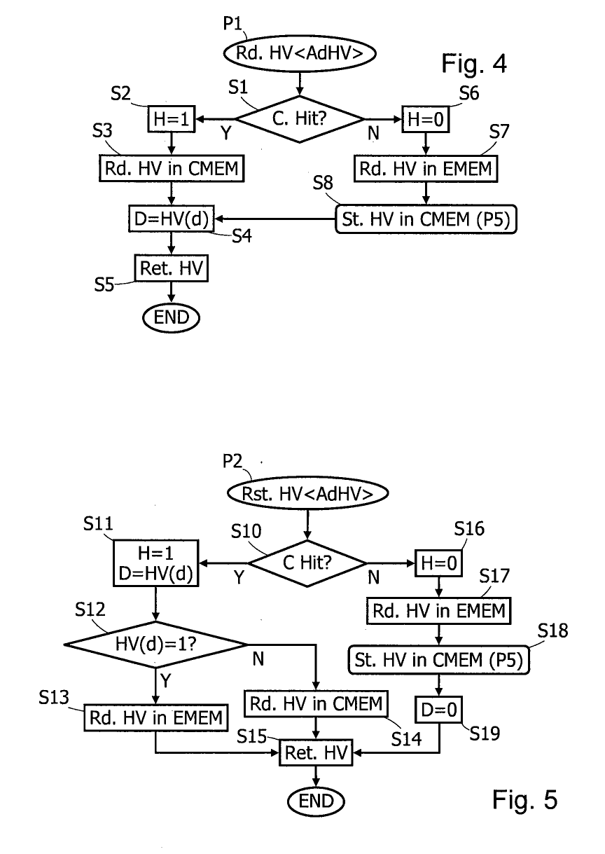

FIGS. 4 to 9 represent processing sequences performed by the unit CCU. FIG. 4 represents a processing sequence P1 performed by the unit CCU when the unit HTM orders the unit CCU to read a signature HV. To activate the sequence P1, the unit HTM puts the signal RW into read state, and the signal CMD for example to 0, and transmits to the unit CCU through the bus ADB a read address AdHV of the signature to be read HV in the memory EMEM. The sequence P1 comprises steps S1 to S5. In step S1, the unit CCU determines, according to the address received AdHV, whether or not the signature to be read HV is in the cache memory. If the signature HV is in the cache memory, the unit CCU successively executes steps S2 to S5, otherwise it successively executes steps S6 to S8, then steps S4 and S5. In step S2, the unit CCU activates the signal H to indicate to the unit HTM that the signature to be read is in the cache memory. In step S3, the unit CCU reads the signature HV in the cache memory.

In step S4, the unit CCU sets the signal D to a state corresponding to the value of the indicator d associated with the signature HV in the memory CMEM. In step S5, the unit CCU finally returns the signature read by the bus ADB to the unit HTM. In step S6, the unit CCU deactivates the signal H to indicate to the unit HTM that the signature HV is not in the cache memory. In step S7, the unit CCU orders the reading of the signature HV at the address AdHV in the memory EMEM. In step S8, the unit CCU executes a processing sequence P5 saving the signature HV read in the memory CMEM. The unit CCU then successively executes steps S4 and S5. According to one embodiment, the unit CCU offers the unit HTM a service enabling the value of a signature to be obtained in the memory EMEM, when the corresponding signature in the memory CMEM has been changed without being saved in the memory EMEM. Therefore, FIG. 5 represents a processing sequence P2 executed by the unit CCU when the unit HTM accesses this service. To activate the sequence P2, the unit HTM puts the signal RW to the read state, and the signal CMD for example to 1, and transmits to the unit CCU through the bus ADB a read address AdHV of the signature to be read HV in the memory EMEM. The sequence P2 comprises steps S10 to S19. In step S10, the unit CCU determines, according to the address received AdHV, whether or not the signature to be read HV is in the memory CMEM. If the signature to be read HV is in the memory CMEM, the unit CCU successively executes steps S11 and S12, or otherwise successively steps S16 to S19, then step S15. In step S11, the unit CCU activates the signal H to indicate to the unit HTM that the signature to be read is in the memory CMEM, and sets the signal D to a state corresponding to the value of the indicator d associated with the signature HV to be read in the memory CMEM. In step S12, the unit CCU tests the indicator d associated with the signature HV to be read. If the indicator d signals that the signature has been changed compared to the value stored in the memory EMEM, the unit CCU executes steps S13 and S15, or otherwise steps S14 and S15. In step S13, the unit CCU reads the value of the signature HV in the memory EMEM at the address AdHV. In step S14, the unit CCU reads the value of the signature HV in the memory CMEM. In step S15, the unit CCU finally returns the value HV of the signature read by the bus ADB. In step S16, the unit CCU deactivates the signal H to indicate to the unit HTM that the signature HV is not in the cache memory. In step S17, the unit CCU orders the reading of the signature HV at the address AdHV in the memory EMEM. In step S18, the unit CCU executes the processing sequence P5 to store the signature HV read in the memory CMEM. In step S19, the unit CCU deactivates the signal D to indicate to the unit HTM that the signature read is identical to the one stored in the memory EMEM. The unit CCU finally executes step S15.

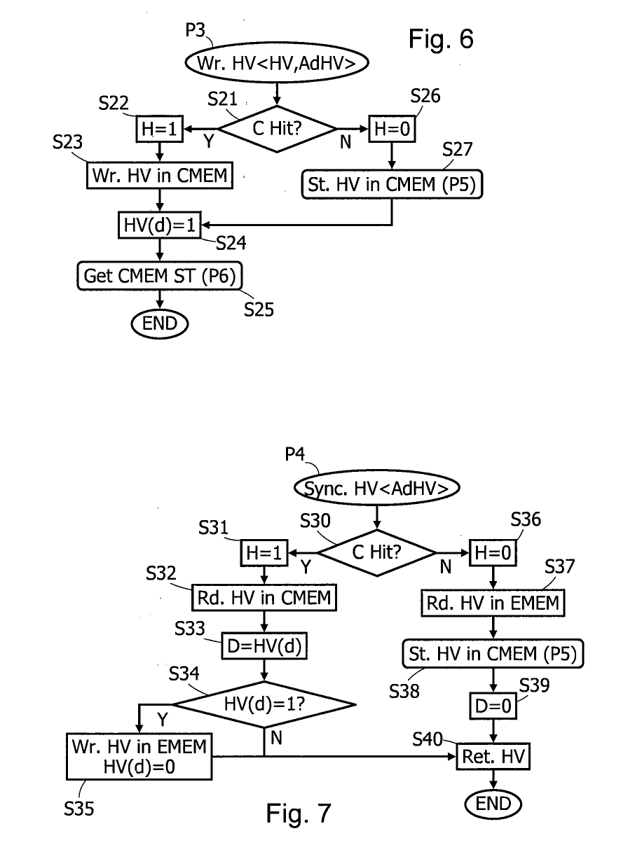

FIG. 6 represents a processing sequence P3 performed by the unit CCU when the unit HTM orders the unit CCU to change a stored signature HV. To activate the sequence P3, the unit HTM puts the signal RW into the write state, and the signal CMD for example to 2, and transmits to the unit CCU through the bus ADB a write address AdHV and a signature value HV to be stored. The sequence P3 comprises steps S21 to S27. In step S21, the unit CCU determines, according to the address received AdHV, whether or not the signature to be changed HV is in the memory CMEM. If the signature HV is in the memory CMEM, the unit CCU successively executes steps S22 to S25, or otherwise it successively executes steps S26, S27, then steps S24 and S25. In step S22, the unit CCU activates the signal H to indicate to the unit HTM that the signature to be read is in the memory CMEM. In step S23, the unit CCU writes the signature HV in the memory CMEM. In step S24, the unit CCU updates the indicator d associated with the signature in the cache memory to signal that the signature has been changed. In step S25, the unit CCU finally executes a sequence P6 of checking the filling rate of the memory CMEM in signatures not saved in the memory EMEM. In step S26, the unit CCU deactivates the signal H to indicate to the unit HTM that the signature HV to be changed is not in the cache memory. In step S27, the unit CCU executes the processing sequence P5 storing the signature HV to be written in the memory CMEM. The unit CCU then finally executes steps S24 and S25.

FIG. 7 represents a processing sequence P4 executed by the unit CCU when the unit HTM orders a read with saving of a signature in the memory EMEM. To activate the sequence P4, the unit HTM puts the signal RW into the read state and the signal CMD for example to 3, and transmits to the unit CCU through the bus ADB an address AdHV of the signature HV to be read and to be saved in the memory EMEM. The sequence P4 comprises steps S30 to S40. In step S30, the unit CCU determines, according to the address received AdHV, whether or not the signature to be read HV is in the memory CMEM. If the signature HV is in the memory CMEM, the unit CCU successively executes steps S31 and S34, or otherwise it executes steps S36 to S40. In step S31, the unit CCU activates the signal H to indicate to the unit HTM that the signature to be read is in the memory CMEM. In step S32, the unit reads the signature HV in the memory CMEM. In step S33, the unit CCU sets the signal D to a state corresponding to the value of the indicator d associated with the signature HV read in the memory CMEM. In step S34, the unit CCU tests the indicator d associated with the signature read in the memory CMEM. If the indicator d signals that the signature HV has been changed compared to the value stored in the memory EMEM, the unit CCU executes steps S35 and S40, or otherwise it executes only step S40. In step S35, the unit CCU saves the value of the signature HV in the memory EMEM at the address AdHV, and deactivates the indicator d associated with the signature to signal that the signature value in the memory CMEM is identical to the one stored in the memory EMEM. In step S40, the unit CCU finally supplies the signature read and saved to the unit HTM. In step S36, the unit CCU deactivates the signal H to indicate to the unit HTM that the signature HV is not in the cache memory. In step S37, the unit CCU orders the reading of the signature HV at the address AdHV in the memory EMEM. In step S38, the unit CCU executes the processing sequence P5 storing the signature HV read in the memory CMEM. In step S39, the unit CCU deactivates the signal D to indicate to the unit HTM that the signature value read is identical to the one stored in the memory EMEM. The unit CCU then finally executes step S40.

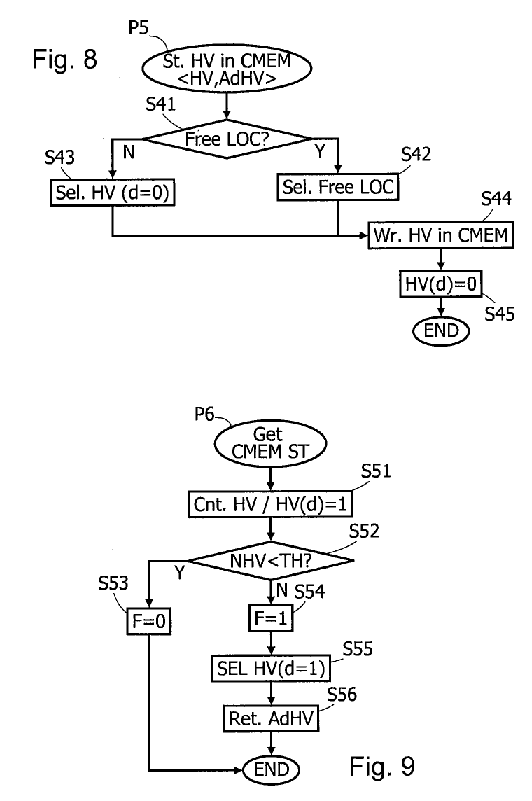

FIG. 8 represents the processing sequence P5 executed by the unit CCU during the execution of the sequences P1 to P4. Upon the activation of the sequence P5, the unit CCU has a signature value and the read address AdHV of the signature HV in the memory EMEM. The sequence P5 comprises steps S41 to S45. In step S41, the unit CCU searches for a vacant location in the memory CMEM. If a vacant location is found, the unit CCU executes step S42, then steps S44 and S45, or otherwise step S42, then steps S44 and S45. In step S42, the unit CCU selects a vacant location in the memory CMEM. In step S43, the unit CCU selects a location in the memory CMEM storing a signature associated with an indicator d signaling that the signature is identical in the memories EMEM and CMEM. Thus, the location of a signature stored in the memory CMEM and not saved in the memory EMEM may not be used to store another signature.

The unit CCU can manage the cache memory CMEM for example in FIFO (First In-First Out) mode, i.e., it selects the location of the least recent datum written in the memory in step S43. According to another example, the unit CCU can manage the cache memory in LRU (Least Recently Used) mode, i.e., it selects in step S43 the location of the datum which was least recently read or written. For this purpose, it may be provided to associate each data location in the cache memory with a counter value or a time indicator TS (FIG. 3) which is updated upon each data write in FIFO mode or upon each write or read in LRU mode. Such a time indicator may not be necessary for example if the signatures are arranged in the cache memory in an order enabling the least recent signatures to be determined using the address of each signature in the cache memory. In one or other of the FIFO and LRU modes, the notion of least recent which is considered by the unit CCU may relate to the branches of the integrity check tree AT, and not to the signatures, if the unit CCU can establish a correspondence between the addresses of the signatures in the memory EMEM and the positions of the signatures in the tree AT. The unit CCU may also use as a priority the locations of the cache memory occupied by the signatures having the highest level in the integrity check tree.

In step S44, the unit CCU writes the signature HV at the selected location. In step S45, the unit CCU finally updates the indicator d associated with the signature HV in the cache memory to signal that the signature in the memory CMEM has an identical value in the memory EMEM.

FIG. 9 represents the sequence P6 of checking the filling rate of the memory CMEM, executed by the unit CCU during the execution of the sequence P3 of storing a changed signature. The sequence P6 comprises steps S51 to S56. In step S51, the unit CCU determines the number NHV of signatures associated with an indicator signaling that the signature has different values in the memories CMEM and EMEM. In step S52, the unit CCU compares the number NHV obtained in step S51 with an occupancy threshold value TH indicating the occupied space in the memory CMEM. If the number obtained NHV is lower than the threshold value TH, the unit CCU executes step S53, otherwise it successively executes steps S52 to S56. In step S53, the unit CCU updates the signal F to indicate to the unit HTM that the memory CCU is not saturated. In step S54, the unit CCU updates the signal F to indicate to the unit HTM that the memory CCU is saturated. In step S55, the unit CCU selects in the memory CMEM a signature HV to be saved in the memory EMEM. For this purpose, if the unit CCU can establish a correspondence between the addresses of the signatures in the memory EMEM and the positions of the signatures in the integrity check tree AT, it can select for example a signature out of the lowest-level signatures in the tree AT. In step S56, the unit CCU finally sends through the bus ADB to the unit HTM the address of the signature selected in step S55.

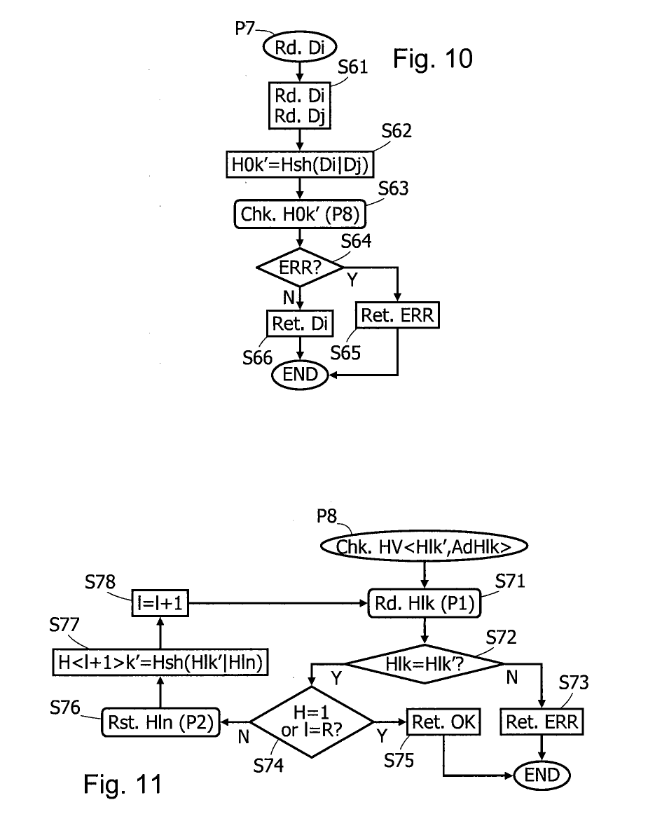

FIGS. 10 to 13 represent processing sequences performed by the unit HTM. FIG. 10 represents a processing sequence P7 executed by the unit HTM when the unit CPU requests the reading of a secure datum Di. The sequence P7 comprises steps S61 to S66. In step S61, the unit HTM reads in the memory EMEM the datum Di to be read and the datum Dj belonging to the same group of data in the integrity check tree AT. In step S62, the unit HTM calculates a signature H0k′ of the data Di and Dj read and previously concatenated. In step S63, the unit HTM executes a processing sequence P8 of checking the integrity of the signature H0k′ obtained. In step S64, the unit HTM tests the indicator returned by the sequence P8. If the indicator returned by the sequence P8 signals an integrity error, the unit HTM signals the error to the unit CPU in step S65, or otherwise the unit HTM sends, in step S66, the value of the datum read and validated Di to the unit CPU.

FIG. 11 represents the processing sequence P8 of checking the integrity of a signature. Upon the activation of the sequence P8, the unit HTM has a signature value to be checked Hlk′ and the read address AdHlk of the signature to be checked in the memory EMEM. The sequence P8 comprises steps S71 to S78. In step S71, the unit HTM orders the unit CCU to execute the sequence P1 to read the signature Hlk. In step S72, the unit HTM compares the signature read Hlk with the signature to be checked Hlk′. If these two signatures Hlk and Hlk′ are different, the unit HTM returns an error indicator in step S73 and the sequence P8 ends. If the two signatures Hlk and Hlk′ are identical, the unit HTM executes step S74 in which it tests the value of the signal H to determine whether or not the signature Hlk most recently read by CCU was in the memory CMEM and tests the value of the level I to determine whether or not the most recently read signature Hlk is the root signature HR. If the most recently read signature is the root signature HR or is in the memory CMEM, the unit HTM executes step S75 supplying the unit CPU with an indicator signaling that the integrity of the signature is valid and the processing sequence P8 ends. It is indeed considered that the signatures stored in the secure memory CMEM are consistent and accurate and therefore that any datum or signature of a group enabling a consistent and accurate signature to be obtained is consistent and accurate even if the signature obtained is not the root signature. If the most recently read signature Hlk is not the root signature HR and is not in the memory CMEM, the unit HTM executes steps S76 to S78. In step S76, the unit HTM orders the unit CCU to execute the sequence P2 to read the value of the signature Hip belonging to the same group of signatures as the most recently read signature Hlk, before it is possibly changed in the memory CMEM. In step S77, the unit HTM calculates the signature H<I+1>k′ of the group comprising the signature previously read Hip and the signature Hlk previously checked. In step S78, a level I index in the integrity check tree AT is incremented by 1. The unit HTM then resumes the execution of the sequence P8 at step S71 to check the most recently calculated signature Hlk′.

If for example the datum D3 has been replaced in the memory EMEM with the datum D3′, the signature H02 concerning the data D3, D4 of the group to which D3 belongs has also been changed, the new value H02′ of this signature is stored in the cache memory EMEM and its associated indicator d is on 1. If, then, the datum D2 must be read and thus its integrity checked, the datum D1 belonging to the same group as the datum D2 is read and the signature H01′ concerning the data of the group D1, D2 is calculated. The signature calculated HO1′ must then be compared with the signature stored H01. If the corresponding signature stored H01 is not in the cache memory, it is then read in the memory EMEM to make the comparison with the signature calculated. Then, the integrity of the signature H01 read must be checked. For this purpose, the signature H11′ concerning the signatures of the group to which the signature H01 belongs must be calculated. If the signature H11′ is calculated from the signature H01 and the signature H02′, the signature obtained H11′ will probably be different from the signature stored H11 if the latter has not been updated since the modification of the signature H02. The sequence P2 enables the previous value of the signature H02 to be accessed as stored in the memory EMEM. The signature H11′ can thus be calculated from H01 and from the former value of H02 (step S76 in the sequence P8) and corresponds to the way in which the signature stored H11 was calculated.

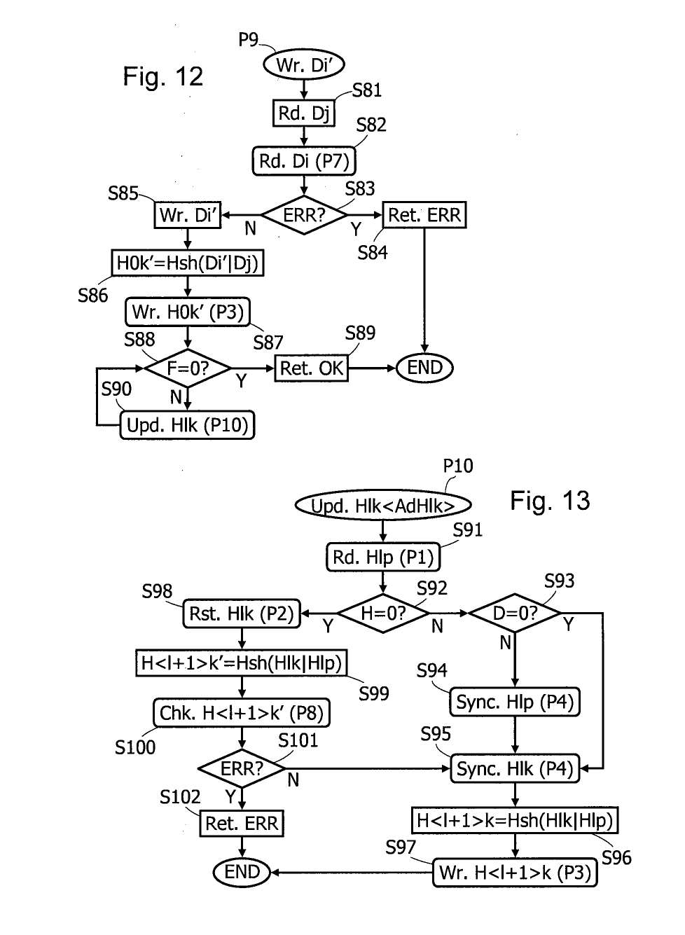

FIG. 12 represents a processing sequence P9 executed by the unit HTM when the unit CPU orders the writing of a datum in the memory EMEM. The unit P9 comprises steps S81 to S90. In step S81, the unit HTM reads the datum Dj belonging to the same group as the datum Di′ to be written. In step S82, the unit HTM executes the sequence P7 to read and check the datum Di stored in the memory EMEM at the address of the datum to be written Di′. It shall be noted that the datum Dj is also checked in step S82, as Di and Dj belong to the same group. In step S83, the unit HTM tests the error indicator returned by the sequence P7. If this indicator signals an integrity error, the unit HTM executes step S84 supplying the unit CPU with an error indicator signaling that the signature is not consistent and accurate and the processing sequence P9 ends. If the indicator does not signal any integrity error, the unit HTM executes steps S85 to S90. In step S85, the unit HTM orders the writing of the datum Di′ in the memory EMEM. In step S86, the unit HTM calculates the signature H0k′ concerning the data Di′ and Dj. In step S87, the unit HTM triggers the execution by the unit CCU of the processing sequence P3 to store the signature calculated H0k′. In step S88, the unit HTM tests the signal F to determine whether or not the occupancy threshold TH indicating the occupied space in the memory CMEM is still reached. If the occupancy threshold of the memory CMEM is not reached (F=0), the unit HTM executes step S89 in which it supplies the unit CPU with an indicator signaling that the datum Di′ has been written and the sequence P9 ends. If the occupancy threshold TH of the memory CMEM is reached (F=1), the unit HTM executes step S90 and resumes the execution of the sequence in step S88. In step S90, the unit HTM calls a processing sequence P10 of saving in the memory EMEM a signature stored only in the memory CMEM. It shall be noted that the value of the threshold TH may be set at the maximum capacity of the memory CMEM as the occupancy of the memory CMEM is checked every time a signature is updated. As a result, even if the value of the threshold TH is set at the capacity of the memory CMEM, the unit CCU can always find a location in step S43 when executing the sequence P5.

FIG. 13 represents the processing sequence P10 of saving a signature Hlk. This sequence is executed by the unit HTM when the signal F sent by the unit CCU indicates that the threshold TH of the number NHV of signatures stored in the memory CMEM and not saved in the memory EMEM is reached. When the signal F is activated by the unit CCU, the unit HTM receives from the unit CCU the address AdHlk of a signature to be saved in the memory EMEM.

The processing sequence P10 comprises steps S91 to S102. In step S91, the unit HTM activates the sequence P1 to order the unit CCU to read the signature Hip belonging to the same group as the signature Hlk to be saved. In step S92, the unit HTM tests the signal H indicating whether or not the signature Hlp read is in the memory CMEM. If the signature Hip is in the memory CMEM, the unit HTM executes step S93, otherwise it executes steps S98 to S102. In step S93, the unit HTM tests the signal D to determine whether or not the signature read Hlp has a different value in the memories CMEM and EMEM. If the signature read Hlp has a different value in the memories CMEM and EMEM, the unit HTM executes steps S94 to S97, otherwise it directly executes steps S95 to S97. In step S94, the unit HTM activates the execution of the sequence P4 by the unit CCU to save the signature Hip in the memory EMEM. In step S95, the unit HTM activates the execution of the sequence P4 by the unit CCU to also save the signature Hlk in the memory EMEM. In step S96, the unit HTM calculates the signature H<I+1>k concerning the signatures Hlk and Hip. In step S97, the unit HTM activates the execution by the unit CCU of the sequence P3 to store the signature calculated H<I+1>k in the memory CMEM, and the sequence P10 ends.

In step S98 executed when the signature Hip is not in the memory CMEM, the unit HTM activates the execution by the unit CCU of the sequence P2 to obtain the value of the signature Hlk in the memory EMEM. In step S99, the unit HTM calculates the signature H<I+1>k′ concerning the signatures H11 and H12 obtained in steps S91 and S98. In step S100, the unit HTM launches the execution of the sequence P8 to check the signature calculated H<I+1>k′. In step S101, if the signature H<I+1>k′ is consistent and accurate, the unit HTM executes steps S95 to S97, otherwise it executes step S102 in which it returns an error signal to the unit CPU.

The sequence P10 enables two signatures of the same group to be saved if both of them have been changed but not saved in the memory EMEM. Otherwise the sequence P10 saves a changed signature, but changes a signature H<I+1>k at the immediately higher level. If the signature changed H<I+1>k was already in the changed state (d=1) before saving the lower-level signature Hlk, the number of unsaved signatures in the memory CMEM decreases by 1. However, if the changed signature H<I+1>k was identical in the memories CMEM and EMEM, the number of unsaved signatures in the memory CMEM remains unchanged. In this last case, the unit CCU may keep the signal F active, so that the unit HTM executes the sequence P10 again.

A processing sequence may also be provided that enables the integrity check tree AT to be fully rebuilt in the memory EMEM from the signatures stored in the memories CMEM and EMEM, in a shutdown procedure of the system SOC, if the memory EMEM is a non-volatile memory. This rebuilding sequence includes calling the sequence P10 every time a signature is changed in the memory CMEM (associated with an indicator d on 1) starting with the first-level signatures until a new root signature value HR is obtained. Similarly, particularly if the memory EMEM is a volatile memory, an initialization sequence may be provided enabling the zones DTV and HTV in the memory EMEM to be initialized by initializing the zone DTV and by building the integrity check tree AT (calculation of signatures) from the initial values of the data.

It will be understood by those skilled in the art that various alternative embodiments and various applications of the present invention are possible. In particular, the present invention is not limited to a hardware implementation of the method by a coprocessor. Indeed, the present invention can also be implemented in a purely software manner with a program executed by a microprocessor connected to a secure memory and an unsecure external memory or by a microcontroller comprising a secure internal memory and connected to a secure external memory. The signals exchanged between the units HTM and CCU, previously described, are then program variables.

More generally, the present invention can also be applied to all systems implementing an integrity check tree to secure data coming from a remote memory, considered to be unsecure, and using a secure memory which is for example local. The data to be secured can thus be files or messages transmitted in a network.

Furthermore, signals other than those previously described can be exchanged between the units HTM and CCU. Thus, other combinations of the signals CMD and RW may be provided to trigger the execution of the processing sequences P1 to P4 by the unit CCU.

Other management modes for managing the cache memory CMEM may be provided. Thus, the cache memory can be divided into sets, each set being capable of receiving signatures having an address in the memory EMEM in which a portion of the bits of the address word is equal to a certain value allocated to the set, each signature being stored in a set in association with the other portion of the bits of its address in the memory EMEM. Different modes of selecting a signature (in steps S43, S55) in the memory CMEM, such as LRU, FIFO, LIFO, etc. may then be applied separately to each set. Some of the sequences P1 to P10 described previously may then have to be adapted. Similarly, a threshold number of changed signatures can be determined for each set in the cache memory. The signal F can thus not remain active if the saving of a signature in the memory EMEM causes another signature to be changed in another set of the memory CMEM.

Moreover, other modes of selecting a signature to be replaced (step S43) in the cache memory CMEM may be provided, particularly if the unit CCU knows the algorithm for ordering the tree in the memory. Thus, it may be provided to combine a traditional time selection mode (LRU, FIFO, LIFO, etc.) with a spatial selection mode based on the knowledge of the position of the signatures in the tree AT. It may also be provided to associate priority levels to each level or each branch of the tree. The unit CCU can then select (step S43) one of the least recently read or written signatures belonging to a level or branch of the tree AT with the highest priority level, with a view to replacing it.

Aspects of the various embodiments described above can be combined and/or modified to provide further embodiments. These and other changes can be made to the described embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
accessing data stored in a secured manner in an unsecure memory, the accessing based on signatures forming an integrity check tree comprising a root signature stored in a secure storage space and signatures with levels lower than the root signature stored in the unsecure memory, the accessing comprising:
calculating a first-level signature from data in a group comprising a changed datum of the integrity check tree;
temporarily storing the calculated signature in a secure memory; and
calculating a signature to check integrity of a first lower-level signature by using the first signature and a second lower-level signature belonging to a same group as the first signature, by:
determining whether the second signature has different values in the secure and unsecure memories; and
in response to determining that the second signature has different values in the secure and unsecure memories, reading the second signature in the unsecure memory.

2. The method of claim 1, further comprising:
determining whether a datum is consistent and accurate, based on whether a signature calculated upon an integrity check of the datum corresponds to a signature read in the secure memory.

3. The method of claim 1, further comprising:
calculating and storing a first-level signature in the secure memory following modification of a datum; and
updating a higher-level signature when the number of signatures having different values in the secure memory and in the unsecure memory exceeds a certain threshold.

4. The method of claim 1, further comprising:
storing a signature in the secure memory in association with an indicator signaling that the signature has different values in the secure memory and in the unsecure memory.

5. The method of claim 1 wherein the secure memory does not have sufficient capacity to store all signatures with levels lower than the root signature in the integrity check tree.

6. The method of claim 1, further comprising:
writing a changed signature value in the secure memory in a location not occupied by a signature having different values in the secure memory and in the unsecure memory; and
saving in the unsecure memory a signature having different values in the secure memory and in the unsecure memory if a threshold number of signatures having different values in the secure memory and in the unsecure memory is reached.

7. The method of claim 1, further comprising:
in response to determining that the second signature does not have different values in the secure and unsecure memories, reading the second signature in the secure memory.

8. A system of processing data, the system comprising:
a secure memory; and
an unsecure memory,
the system being configured for storing data in a secured manner in an unsecure memory, the storing based on signatures forming an integrity check tree comprising a root signature stored in a secure storage space and signatures with levels lower than the root signature stored in the unsecure memory, the storing of data in the secured manner including:
calculating a first-level signature from data in a group comprising a changed datum in the integrity check tree;
storing the signature calculated in the secure memory; and
calculating a signature to check integrity of a first lower-level signature by using the first signature and a second lower-level signature belonging to a same group as the first signature, by:
determining whether the second signature has different values in the secure and unsecure memories; and
in response to determining that the second signature has different values in the secure and unsecure memories, reading the second signature in the unsecure memory.

9. The system of claim 8, configured for considering a datum to be consistent and accurate when a signature calculated upon an integrity check of the datum corresponds to a signature read in the secure memory.

10. The system of claim 8, configured for calculating a first-level signature and storing it in the secure memory following the modification of a datum, and for updating a higher-level signature when the number of signatures having different values in the secure memory and in the unsecure memory exceeds a certain threshold.

11. The system of claim 8, configured for storing a signature in the secure memory in association with an indicator signaling that the signature has different values in the secure memory and in the unsecure memory.

12. The system of claim 8 wherein the secure memory does not have sufficient capacity to store all signatures with levels lower than the root signature in the integrity check tree.

13. The system of claim 8, comprising a processing unit, an integrity check tree management unit connected to the processing unit, and a control unit connected to the management unit, to the secure memory and to the unsecure memory, the management unit being configured for executing read and write commands for reading and writing a secure datum sent by the processing unit while checking the integrity of the datum to be read or to be written using the integrity check tree.

14. The system of claim 13 wherein the control unit is configured for executing commands sent by the management unit for reading and updating a signature in the integrity check tree, for reading a signature in the unsecure memory if the signature has different values in the secure and unsecure memories, and for saving in the unsecure memory a changed signature stored in the secure memory.

15. The system of claim 13 wherein the control unit is configured for controlling a filling rate of the secure memory in changed signatures not saved in the unsecure memory.

16. The system of claim 12 wherein the management unit, the control unit and the secure memory are produced in a coprocessor connected between the processing unit and the unsecure memory.

17. The system of claim 8 wherein the secure memory stores for each signature a signature value, a storage address for storing the signature in the unsecure memory and a counter value TS which is updated every time the signature is written or every time the signature is written and read, the control unit using the counter value to determine a signature stored in the secure memory which was the least recently written or the least recently read and written.

18. The system of claim 8, wherein the calculating includes, in response to determining that the second signature does not have different values in the secure and unsecure memories, reading the second signature in the secure memory.

19. A method, comprising:
accessing data stored in a secured manner in an unsecure memory, the accessing based on signatures forming an integrity check tree comprising a root signature stored in a secure storage space and signatures with levels lower than the root signature stored in the unsecure memory, the accessing comprising;
calculating a first signature from data in a group comprising a changed datum;
storing the first signature in a secure memory;
checking integrity of a second signature that belongs to the same group as the first signature by calculating a signature based on the second signature and a previous value of the first signature, the previous value of the first signature being read in the unsecure memory.

20. The method of claim 19, further comprising:
providing an indication that a datum of the data the group comprising the changed datum is consistent and accurate, based on whether a signature calculated from the data in the group comprising the changed datum corresponds to the stored first signature in the secure memory.

21. The method of claim 19, further comprising:
following modification of a datum, calculating and storing a first-level signature in the secure memory; and
updating a higher-level signature when a threshold number of signatures having different values in the secure memory and in the unsecure memory is reached.

22. The method of claim 19 wherein storing the first signature in the secure memory includes storing the first signature in a least-recently accessed location in the secure memory.

23. The method of claim 19 wherein accessing the data includes accessing files received via a network from a remote unsecure memory.
